(19) United States
(12) Patent Application Publication
(10) Pub. No.: US 2013/0268318 A1
(43) Pub. Date: Oct. 10, 2013

(54) Systems and Methods for Temporal Reconciliation of Forecast Results

(71) Applicant: SAS INSTITUTE INC., Cary, NC (US)

(72) Inventor: Victor H. Richard, Appleton, WI (US)

(73) Assignee: SAS Institute Inc., Cary, NC (US)

(21) Appl. No.: 13/723,347

(22) Filed: Dec. 21, 2012

Related U.S. Application Data
(60) Provisional application No. 61/620,194, filed on Apr. 4, 2012.

(51) Int. Cl. G06Q 30/02; G06Q 50/06

(52) U.S. Cl. CPC G06Q 30/0202; G06Q 50/06
USPC 705/7.31

(57) ABSTRACT

In accordance with the teachings described herein, systems and methods are provided for generating a forecast. A first forecast model of a first type is applied to generate first forecast results. A second forecast model of a second type is applied to generate second forecast results. The first and second forecast results are combined using an optimization model to generate combined forecast results, where the optimization model applies one or more constraints to preserve one or more attributes of the first or second forecast results in the combined forecast results.

### CROSS-REFERENCE TO RELATED APPLICATIONS

This application claims priority to U.S. Provisional Patent Application No. 61/620,194, filed Apr. 4, 2012, entitled “Mechanism to Facilitate Temporal Reconciliation with Additional Constraints,” which is herein incorporated by reference in its entirety.

### FIELD

The technology described in this patent document relates generally to systems and methods for generating a forecast and more particularly to computer-implemented systems and methods for performing temporal reconciliation of forecast results generated by multiple forecasting models.

### BACKGROUND

Planning is a process where the conditions and actions necessary to move an individual or organization from one state to a desired state are determined. This process can combine an understanding of an entity or entities under study, forecasting both internal and external developments with the potential to impact the entity or entities, and preparation and analysis of scenarios allowing a decision maker to explore how to react to the developments.

Demand forecasting can be a component of planning systems. Demand forecasting systems attempt to predict the future as accurately as possible, given the information available (e.g., historical data and knowledge of future events that might impact the forecast). Planning may be a response to forecasts and goals and may involve determining appropriate actions that are required to make the forecasts match the goals.

### SUMMARY

In accordance with the teachings described herein, systems and methods are provided for generating a forecast. In a method for generating a forecast, a first forecast model of a first type is applied to generate first forecast results. A second forecast model of a second type is applied to generate second forecast results. The first and second forecast results are combined using an optimization model to generate combined forecast results, where the optimization model applies one or more constraints to preserve one or more attributes of the first or second forecast results in the combined forecast results.

The method may further include setting the one or more constraints based on a type of data being forecast or based on a domain type to which the forecast applies. The domain type may relate to a particular industry or a business type. The particular industry or business type may relate to electrical power generation.

The method may further include applying the first forecast model, where the first forecast model is a short-term forecast model, and applying the second forecast model, where the second forecast model is a medium-term forecast model. The short-term forecast model may generate an hourly forecast, and the medium-term forecast model may generate a monthly or yearly forecast.

The method may further include applying the first forecast model, where the first forecast model is a time-series forecast model, and applying the second forecast model, where the second forecast model is an econometric forecast model. The one or more constraints may be applied to cause an aggregate demand forecasted by the econometric forecast to be preserved in the combined forecast results. The one or more constraints may be applied to preserve magnitudes of peaks of the time-series forecast model in the combined forecast results. The one or more constraints may be applied to require that no new peaks are created in the combined forecast results. The one or more constraints may be applied to preserve temporal locations of peaks of time-series forecast results in the combined forecast results.

The method may further include using the optimization model to associate an adjustment variable with time-series values from the first forecast results and to apply an objective function to minimize the adjustment variables. The objective function may be applied to minimize the adjustment variables by minimizing a sum of the squared adjustment variables.

The method may further include receiving the one or more constraints from a user via a user interface. The method may also include displaying a graphical representation of the combined forecast results. The method may also include using the optimization model to apply the one or more constraints to preserve attributes of both the first and the second forecast results in the combined forecast results.

A system for generating a forecast includes a first forecasting engine configured to apply a first forecast model of a first type to generate first forecast results. The system also includes a second forecasting engine configured to apply a second forecast model of a second type to generate second forecast results. The system further includes an optimization engine configured to combine the first and second forecast results using an optimization model to generate combined forecast results. The optimization model applies one or more constraints to preserve one or more attributes of the first or second forecast results in the combined forecast results.

The system may further include a data acquisition and preparation module configured to provide data or instructions to the first and the second forecasting engines. The data acquisition and preparation module may be configured to provide second data or instructions to the optimization engine, and the second data or instructions may be used in combining the first and second forecast results. The second data or instructions may include the one or more constraints, and the data acquisition and preparation module may be configured to analyze input data samples to determine the one or more constraints.

The system may further include a presentation and reporting module configured to produce a graph or report of the combined forecast results. The system may also include a user interface configured to accept an input from a user or display an output of the system. The input may include the one or more constraints. The output may include a graphical representation of the first forecast results, the second forecast results, or the combined forecast results.

A computer program product for generating a forecast, tangibly embodied in a machine-readable non-transitory storage medium, includes instructions configured to cause a data processing system to apply a first forecast model of a first type to generate first forecast results. The data processing system is also configured to apply a second forecast model of a second type to generate second forecast results. The data processing system is further configured to combine the first and second forecast results using an optimization model to generate combined forecast results. The optimization model applies one or more constraints to preserve one or more attributes of the first or second forecast results in the combined forecast results.

### BRIEF DESCRIPTION OF THE DRAWINGS

FIG. 1 is a block diagram of an example forecast reconciliation system for combining the results from multiple forecasting models.

FIGS. 2A, 2B, and 2C illustrate aspects of an example scenario where forecasting results of an econometric forecast model at a monthly level are combined with results of a detailed hourly time-series forecast model.

FIG. 3 is a block diagram of another example forecast reconciliation system for combining the results from multiple forecasting models.

FIG. 4 depicts an example optimization model that may be applied by an optimization engine to generate combined forecasting results.

FIG. 5 is a block diagram depicting another example of a forecast reconciliation system.

FIG. 6 is a flowchart depicting operations of an example method for generating a forecast.

FIGS. 7A, 7B, and 7C depict example systems for use in generating a forecast.

### DETAILED DESCRIPTION

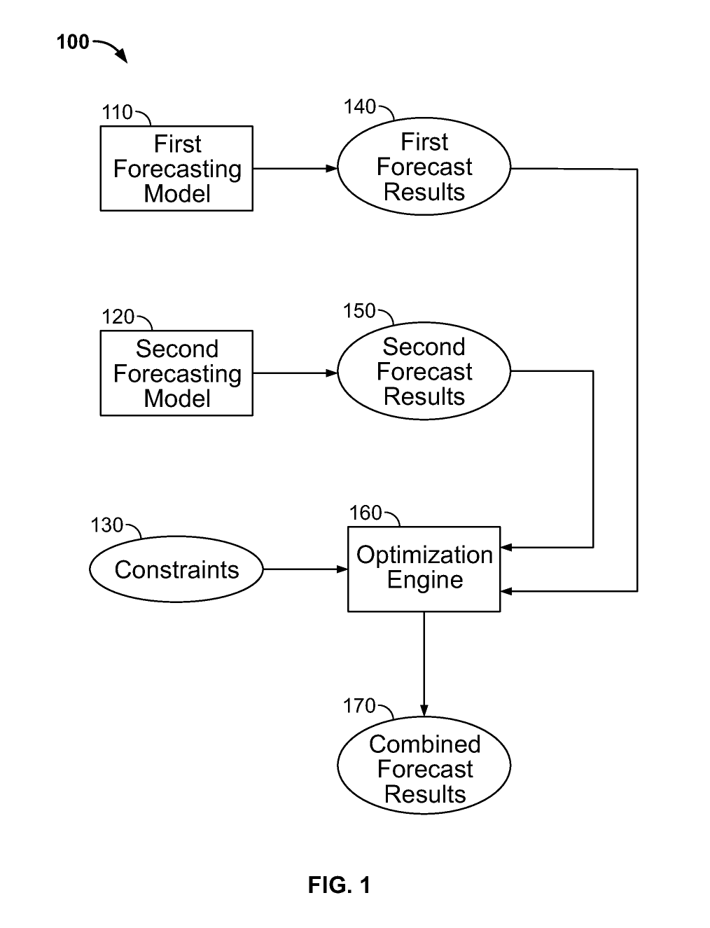

FIG. 1 is a block diagram of an example forecast reconciliation system 100 for combining the results from multiple forecasting models 110, 120. In operation, the forecast reconciliation system 100 applies one or more constraints 130 in order to combine forecast results 140, 150 from the multiple forecasting models 110, 120 in such a way that one or more attributes of the forecast results 140, 150 may be preserved in combined forecast results 170.

In the illustrated example 100, the forecast reconciliation system 100 includes a first forecasting model 110 of a first type and a second forecasting model 120 of a second type that respectively generate first and second forecasting results 140, 150. As an example, one forecasting model 110 may be a medium-term forecasting model such as an econometric model, and the other forecasting model 120 may be a short-term forecasting model such as a time-series model. The econometric model may be based on multiple regression techniques and may be used to incorporate macro-level variables such as weather, population shifts, industrialization level, etc. into a monthly demand forecast. The time-series model may be used to determine the hourly demand patterns at, for example, a meter level. The first and second forecasting models 110, 120 may be executed by one or more forecasting software applications executing on the same or different computer systems.

The forecast results 140, 150 are received by an optimization engine 160 that combines the forecast results using an optimization model to generate the combined forecast results 170. The optimization model utilized by the optimization engine 160 applies the one or more constraints 130 in order to preserve one or more attributes of the first or second forecast results 140, 150 in the combined forecast results 170. The optimization engine 160 used to generate the combined forecast results 170 may be implemented by software instructions that are stored in one or more computer-readable mediums and are executed by one or more processors.

In an example, attributes of both the first and the second forecast results 140, 150 are preserved in the combined forecast results 170. Preservation of important forecasting information from both the first and the second forecast results 140, 150 may be important, for example, in the provision of utilities (e.g., electricity, natural gas, water), among other fields. In such fields, a forecast may not be adequate if it solely reflects short-term (e.g., hourly) forecasts or solely reflects medium- or long-term (e.g., monthly) forecasts. As a basic example, in forecasting demand for electric power by customers of a public utility, it is generally inadequate to predict a monthly demand for the electric power and to then assume that the electric power will be used at a constant rate at all hours of all days of the month. Such an assumption ignores the realities of demand for electric power, which includes, for example, peak demand periods in which electric power is in demand at a higher than average supply level. Thus, the combined forecast results 170 may take into account both short-term forecasts and medium- or long-term forecasts to produce a combined forecast that more accurately reflects reality.

The combined forecast results 170 may incorporate several types of forecasts in predicting uncertain events. Short-term forecasts may, for example, be used for operational scheduling of personnel, production, equipment, and transportation. Medium-term forecasts may, for example, be used to determine future resource requirements in order to purchase raw materials, hire personnel, or buy machinery and equipment. Long-term forecasts may, for example, be used in strategic planning where decisions take account of market opportunities, environmental factors, and internal resources. In some cases, each of the forecasting levels may incorporate different classes of information as input. In the utilities domain (e.g., electricity, natural gas, petroleum, and water companies), short, medium, and long term forecasts are often utilized in support of different planning functions, and the forecasts are often developed using different techniques and toolsets.

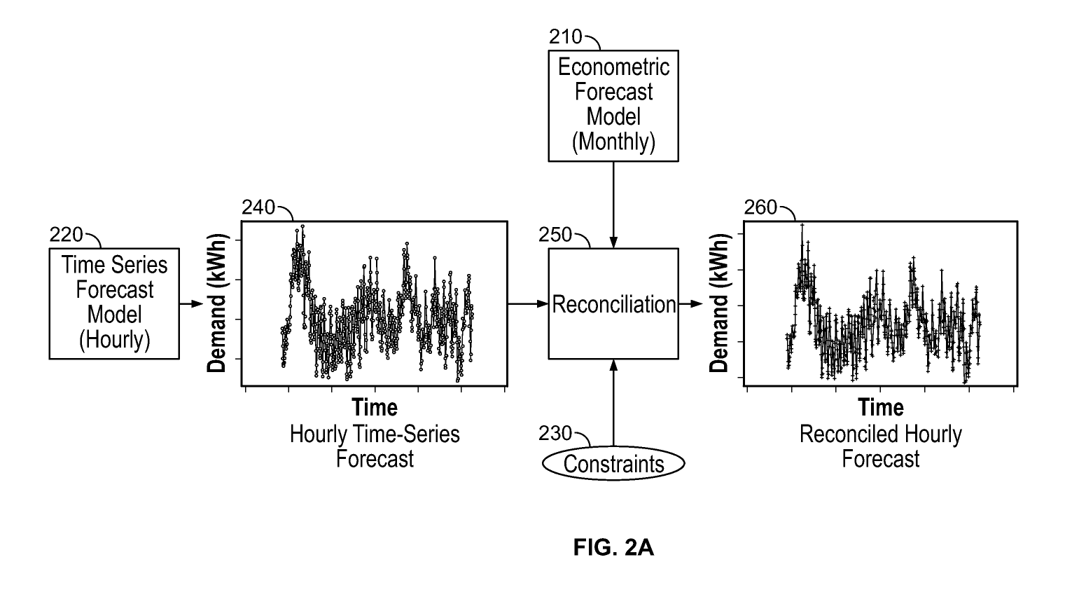

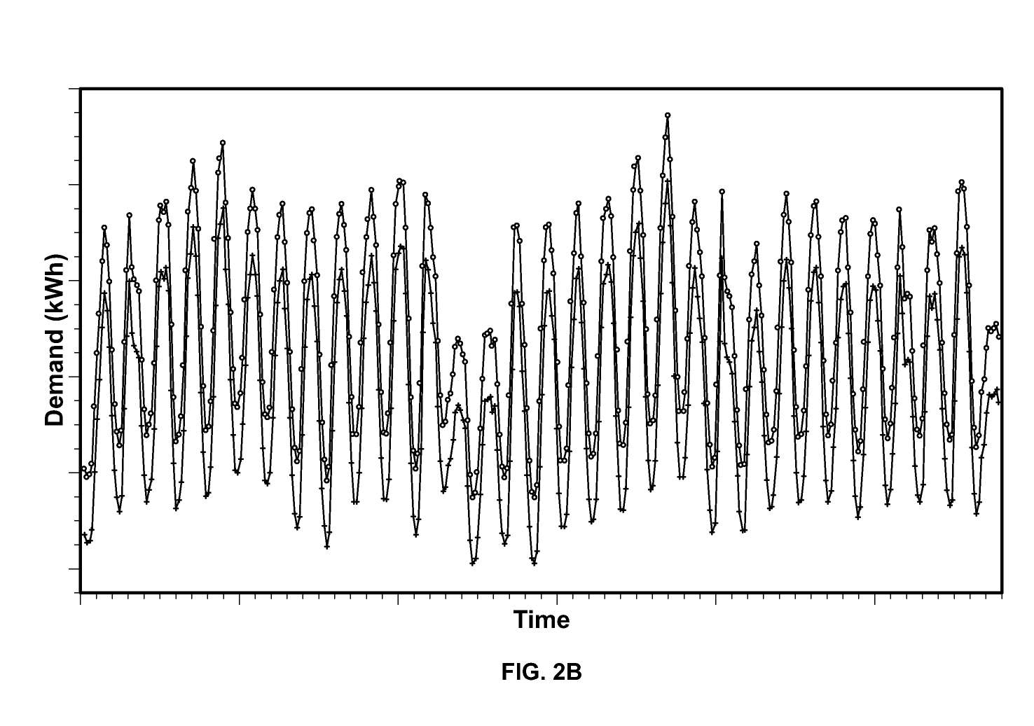

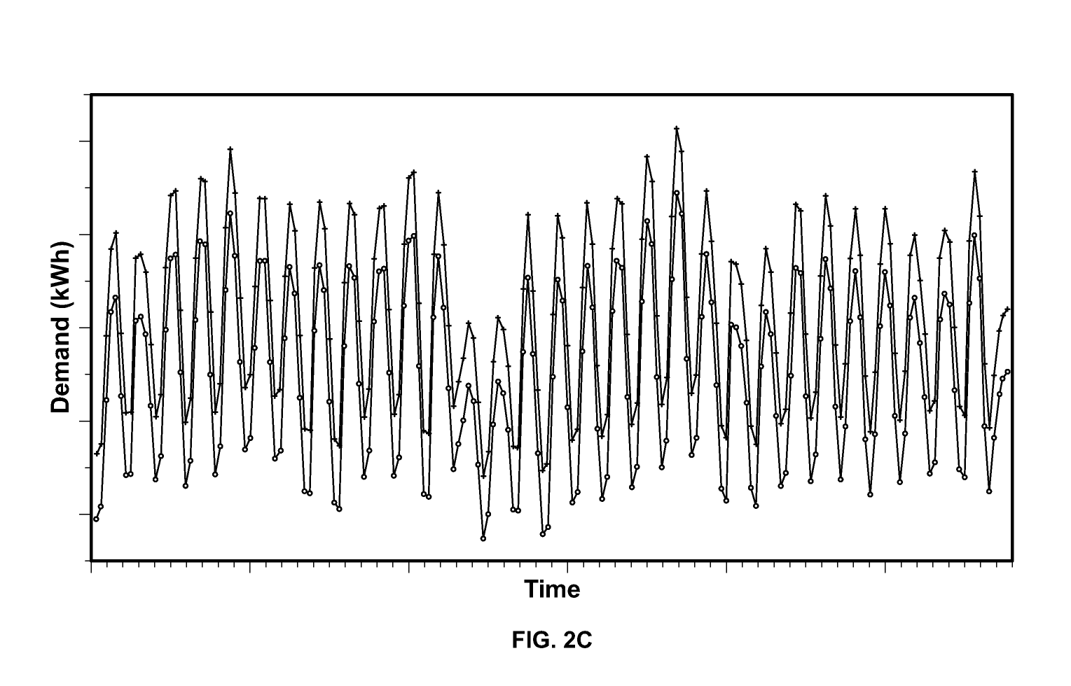

FIG. 2A illustrates an example in which forecasting results of an econometric forecast model 210 at a monthly level are combined with results of a detailed hourly time-series forecast model 220. The combining of the monthly and hourly results involves a reconciliation process 250 that preserves key aspects of both the monthly and hourly results. In FIG. 2A, one or more constraints 230 are applied to preserve the demand peaks of an hourly time-series forecast 240 produced by the time-series forecast model 220 while ensuring that the total energy demand is equal to the aggregate demand forecasted by the econometric forecast model 210. In certain applications, for example, the demand patterns from the hourly time-series forecast 240 may be important for long-term planning. For instance, in the electrical utility domain, peaks in the short-term forecasting results that are indicative of peak loading times may be an important consideration in long-term production and transmission capacity planning. Therefore, in the case of an electrical utility, constraints for combining the results of a monthly econometric model with an hourly time-series model may include constraints on the time of occurrence for the peak demands and the magnitude of these peaks.

The pattern of peaks and valleys that is included in the hourly time-series forecast 240 of FIG. 2A is typically not reflected in the forecasting results of the econometric forecast model 210. The temporal occurrence of the peaks and valleys is driven by the demand patterns of the region under study, along with factors such as industrial usage timing and residential use patterns, among others. Such demand patterns and factors may not be reflected in the forecasting results of the econometric forecast model 210 because the econometric forecast model 210 may be driven by higher-level variables (e.g., weather, population shifts, and industrialization level) that do not directly affect demand at an hourly level. Thus, in one example, the econometric forecast model 210 may be used to generate an aggregate demand level for a month but may include little or no information as to how the aggregate demand is allocated across days and hours of the month.

In performing the reconciliation process 250 to produce a reconciled hourly forecast 260, the time of the demand peaks and their magnitudes are preserved while simultaneously allocating the monthly demand pattern of the econometric model 210 across the hourly demand pattern 240. The preservation of aspects from both the time-series forecast model 220 and the econometric forecast model 210 is accomplished using the constraints 230. The result illustrated in the reconciled hourly results 260 is a detailed hourly demand forecast that exhibits the pattern of the initial hourly results 240 and that has a total monthly demand that matches the forecasting results of the econometric forecast model 210.

FIG. 2B is an example graph depicting data from the reconciled hourly forecast 260 superimposed over data from the hourly time-series forecast 240. In FIG. 2B, the x-axis represents time (e.g., each tick mark may be a 1-hour increment or a 4-hour increment), and the y-axis represents a forecasted value (e.g., demand level in kWh). The data from the hourly time-series forecast 240 are depicted using “circles” as data points, and the data from the reconciled hourly results 260 are depicted using “plus signs” as data points. In the example graph of FIG. 2B, the forecasting results from the econometric forecast model 210 indicate a drop in aggregate demand for the month (i.e., determined using information that is not available to the hourly time-series forecast model 220 and hence not reflected in the hourly time-series forecast 240). In the example graph of FIG. 2B, the increase forecasted by the econometric forecast model 210 is approximately 5,000 kWh over the month. Thus, the data from the reconciled hourly results 260 is of lower magnitude than the data from the hourly time-series forecast 240 to reflect the drop in total aggregate demand. The data from the reconciled hourly forecast 260 retains the overall demand pattern of the hourly time-series forecast 240. The retention of the overall demand pattern from the hourly time-series forecast 240 causes the reconciled hourly results 260 to have peaks occurring at the same times as peaks of the hourly time-series forecast 240 and to have peak magnitudes that deviate a relatively small amount from those of the hourly time-series forecast 240.

FIG. 2C is another example graph depicting data from the reconciled hourly forecast 260 superimposed over data from the hourly time-series forecast 240. In FIG. 2C, the x-axis represents time, and the y-axis represents a forecasted value. As in FIG. 2B, the data from the hourly time-series forecast 240 are depicted using “circles” as data points, and the data from the reconciled hourly results 260 are depicted using “plus signs” as data points. In the example graph of FIG. 2C, the forecasting results from the econometric forecast model 210 indicate an increase in aggregate demand for the month. In the example graph of FIG. 2C, the increase forecasted by the econometric forecast model 210 is approximately 5,000 kWh over the month. Thus, the data from the reconciled hourly results 260 is of higher magnitude than the data from the hourly time-series forecast 240 to reflect the increase in total aggregate demand. The data from the reconciled hourly forecast 260 retains the overall demand pattern of the hourly time-series forecast 240.

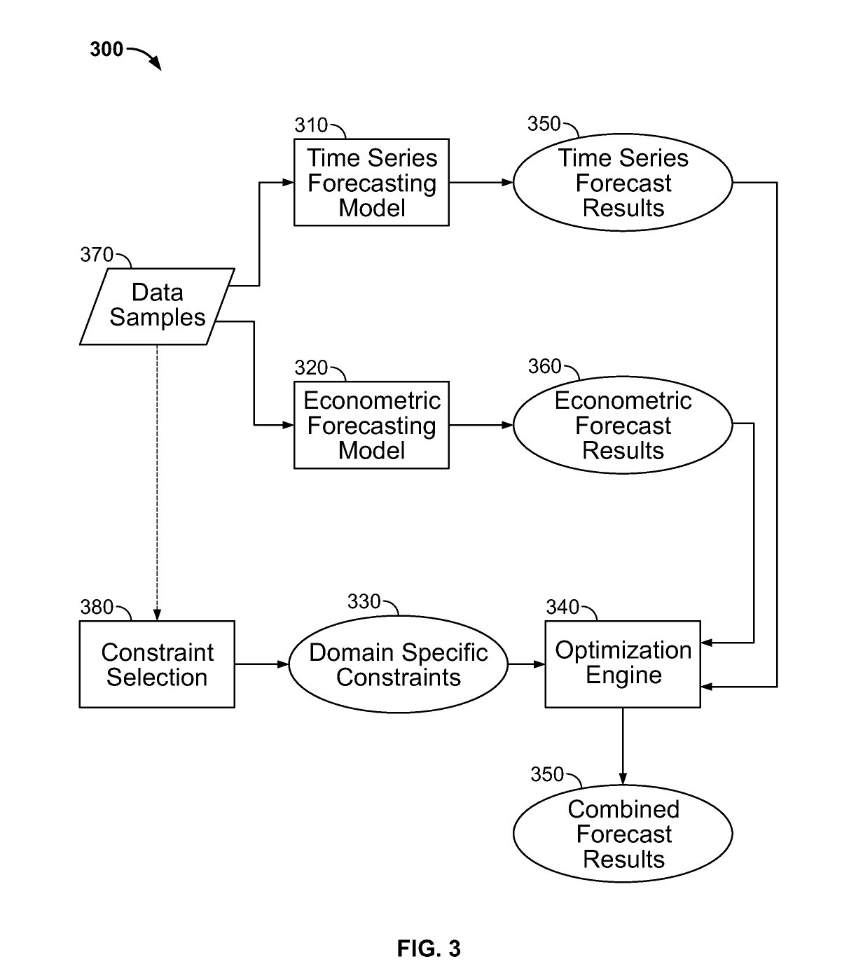

FIG. 3 is a block diagram of another example forecast reconciliation system 300 for combining the results from multiple forecasting models 310, 320. In this example, constraints 330 applied by the optimization engine 340 to preserve one or more attributes of individual forecasting results 350, 360 are selected based on the specific domain in which the forecast is being performed. A domain refers to an area or context in which the forecasting operation is being performed. For example, the domain may be a particular business or business type, such as an electrical utility business. In the example illustrated in FIG. 3, the applied constraints 330 are specifically tailored to the domain in which the forecasting operation is being performed. For example, if the domain is electric utilities, then the constraints 330 may be selected to preserve one or more attributes of the individual forecasting results 350, 360 that may be important for long-term planning in the electric utility business.

The example illustrated in FIG. 3 includes a time-series forecasting model 310 and an econometric forecasting model 320 that respectively generate time-series forecast results 350 and econometric forecast results 360. The time-series and econometric forecasting models may, for example, be utilized by one or more forecasting software applications that use data samples 370 to fit the models and produce the forecast results. The data samples 370 may include, for example, historic data of past demand patterns. In one example, the time-series and econometric forecasting results 350, 360 may be generated using the SAS/ETS® Software or SAS/OR Software® sold by SAS Institute Inc. of Cary, N.C.

The data samples 370 may be utilized by a constraint selection engine 380 in order to identify the one or more domain-specific constraints 330 for use by the optimization engine 340. For example, the constraint selection engine 380 may analyze the data samples 370 to identify the domain in which the data was generated and then select the one or more constraints 330 based on the identified domain. As an example, if the data samples 370 include historic time-series data relating to electricity usage, then the constraint selection engine 380 may determine that the forecasting results are specific to an electric utility domain and select a set of one or more constraints 330 that are specific to this domain. In other examples, the one or more domain-specific constraints 330 may be selected by the constraint selection engine 380 based on user input. For instance, in certain examples, the constraint selection engine 380 may enable a user to select from multiple predetermined sets of constraints based on the domain type or may enable a user to manually set one or more constraints.

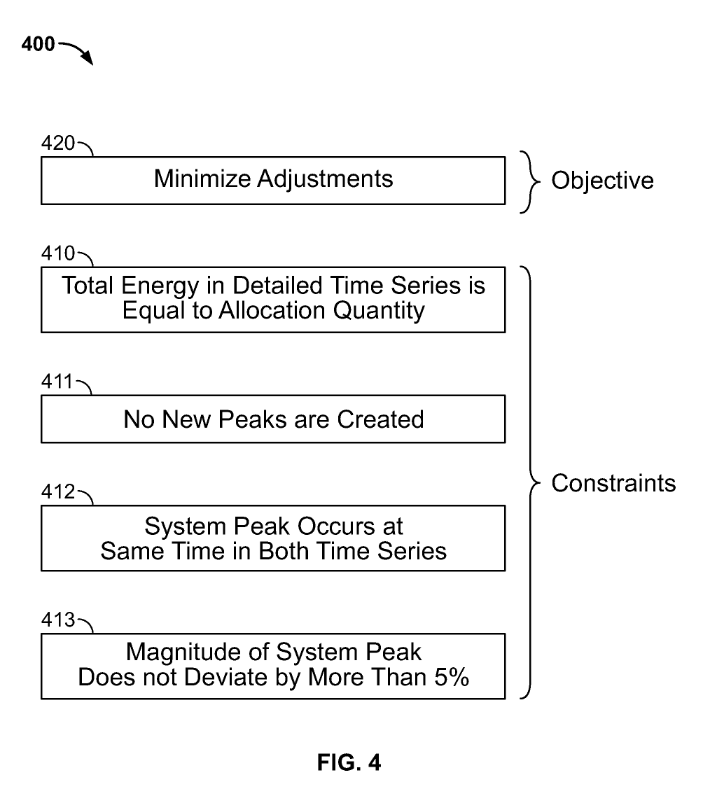

The optimization engine 340 uses an objective function to combine the forecasting results 350, 360 subject to the one or more domain-specific constraints 330 to generate the combined forecasting results 350. An example of an optimization model that may be applied by the optimization engine 340 to generate the combined forecasting results 350 is illustrated in FIG. 4.

The example optimization model 400 illustrated in FIG. 4 is specific to an electric utilities domain and is intended to preserve the integrity of a detailed demand pattern in a time-series forecast while at the same time incorporating a total energy demand forecast from an econometric forecasting model. The optimization model 400 includes linear, domain-specific constraints 410-413 and a nonlinear objective function 420. More specifically, the optimization model is formulated so that the time of occurrence and magnitude of peak demands in an hourly time-series forecast are preserved when combined with a monthly econometric forecast. The intent of the example optimization model is thus to incorporate the aggregate information from the econometric model into the detailed time-series forecast with minimum perturbations.

In order to generate the objective function for the optimization model, an adjustment value may be associated with each predicted value from the time-series forecast model. The adjustment values may reflect the amount of adjustment required at each of the predicted values of the time-series forecast model due to the incorporation of the aggregate demand information from the econometric model. In order to keep the adjustment values as small as possible, thereby maintaining the overall pattern of the detailed time-series forecast, the objective function is designed to minimize the sum of the squared adjustments plus some artificial variables added to encourage desired properties of the solution. The optimization is then performed subject to the set of domain-specific constraints.

In the example illustrated in FIG. 4, the domain is electric load forecasting, and the domain-specific constraints reflect physical behavior of demand patterns in that domain. It should be understood, however, that the same technique may be applied to other domains by developing constraint sets that reflect the behaviors of those specific domains. The first constraint 410 in the example of FIG. 4 can force the total electrical demand in the time-series model to be equal to the aggregate demand that is specified in the econometric model. As an example, the econometric model may produce an output forecasting the aggregate demand for electric power for a time period of a month or a year. The first constraint 410 is used to ensure that the forecasted demand for the month or the year is maintained when combining these forecast results with the time-series results, which may be forecasted at, for example, an hourly level.

The pattern of peaks and valleys that are reflected in the time-series forecast in an electric load forecasting domain may not be typically reflected in a higher-level econometric model. The temporal occurrence of the peaks and valleys may be driven by the demand patterns of the region under study, along with factors such as weather patterns, industrial usage timing, residential use patterns, etc. It may be desirable to preserve these overall patterns in the combined forecasting results. With reference again to FIG. 4, the remaining constraints 411-413 are used to preserve the overall peak and valley pattern of the time-series forecast results. The second constraint 411 in the example of FIG. 4 inhibits the creation of new peaks across the time horizon of study. The third constraint 412 forces a timing of each of the peaks to be the same in both time-series. The fourth constraint 413 prevents a magnitude of each of the peaks from deviating more than 5% from those of the original time-series model.

As an example, the following model structure may be used for the domain-specific model illustrated in FIG. 4.

Objective Function:

min obj=sum{e in emc,s in sa,t in tp}XX[e,s,t,]̂2+sum{e in emc}99*S1[e]

where the variable XX[ . . . ] is the applied adjustment for each point in the detailed time-series forecast, the variable S1[ . . . ] is an artificial variable that maintains feasibility, and e, s, and t are index values for the S1 and XX variables, where e is an EMC (Electric Membership Corporation or Electric Membership Cooperative) region, s is a service area, and t is time. Thus, the example objective function includes the sum of the adjustments made, squared, for each term of the detailed time-series plus an artificial term that maintains feasibility.

Constraints:

constraint LF{e in emc,s in sa}:sum{t in tp}(XX[e,s,t]+xPV[e,s,t])=allqty[e] (1)

Constraint (1) requires the sum of the detailed time-series values, xPV, and the adjustment values, XX, over the entire time period to be equal to the allocation quantity, allqty. The allocation quantity is the total demand over the aggregated time period.

constraint NZ{e in emc,s in sa,t in tp}:XX[e,s,t]+xPV[e,s,t]≧0.0 (2)

Constraint (2) requires that the forecast value plus the adjustment value is greater than or equal to zero for all time periods. This constraint is included because a demand value of less than zero makes no sense in the context of electricity generation and distribution.

constraint NNP{e in emc,s in sa,t in tp}:XX[e,s,t,]+xPV[e,s,t]≦emax[e]+S1[e] (3)

Constraint (3) inhibits the creation of new peak values for each demand region.

constraint MHA{e in emc,s in sa,t in tp}:XX[e,s,t]≦0.10*emax[e] (4)

Constraint (4) is used to limit the maximum adjustment that can be applied for any given hour.

constraint SAP{s in sa,t in tp}:sum{e in emc}(XX[e,s,t]+xPV[e,s,t])≧smax[s] (5)

Constraint (5) prevents the creation of a new peak across an entire service region. Additional constraints may be applied as used to control the reconciliation process. The need for additional constraints may be dependent on the application domain and the relative granularity of the forecast results being reconciled.

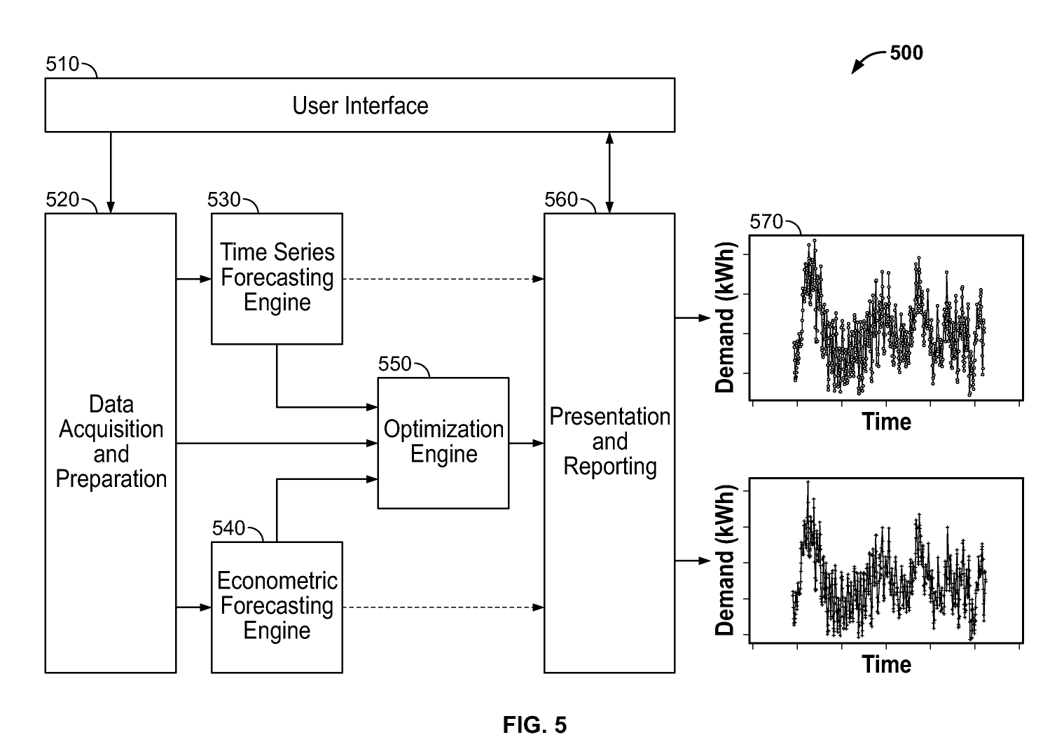

FIG. 5 is a block diagram depicting another example of a forecast reconciliation system 500. In this example, the system 500 includes a user interface 510, a data acquisition and preparation module 520, a time-series forecasting engine 530, an econometric forecasting engine 540, an optimization engine 550, and a presentation and reporting module 560. The system components 510-560 illustrated in FIG. 5 may be implemented by software instructions that are stored in one or more computer-readable mediums and are executed by one or more processors. For example, the system of FIG. 5 may be implemented in Base SAS® or SAS/OR Software® sold by SAS Institute Inc. of Cary, N.C.

The user interface 510 provides input and output functions to facilitate user interaction with the system 500. For example, user-specified constraints may be input by a user via the user interface 510, which may be a graphical user interface. The user interface may also be used, for example, to display output graphs produced by the system, such as those at 570 of FIG. 5. The data acquisition and preparation module 520 may be used to compile and provide data or instructions to the forecasting engines 530, 540 for the purpose of generating the respective forecasting results. For example, the data acquisition and preparation module 520 may access data provided via the user interface 510 or via a different input data source (e.g., a server, database, disk drive, memory, etc.). The data may be raw data or data samples used in producing forecast results (e.g., historic data of past demand patterns). The data acquisition and preparation module 520 may also employ a constraint selection engine (e.g., the constraint selection engine 380 of FIG. 3) that analyzes input data and then selects one or more constraints based on the analysis. In addition, the data acquisition and preparation module 520 may also provide instructions and/or data to the optimization engine 550 for use in combining the results from the forecasting models 530, 540. For example, the data acquisition and preparation module 520 may compile and provide a set of domain-specific constraints to the optimization engine 550.

The time-series and econometric forecasting engines 530, 540 are used to produce the short (e.g., hourly) and medium-term (e.g., monthly) forecast results to be combined by the optimization engine 550. As illustrated in FIG. 5, the forecasting engines 530, 540 may also be in direct communication the presentation and reporting module 560. This allows the presentation and reporting module 560 to produce graphical representations of the time-series and econometric forecast results, such as those at 570 of FIG. 5. The optimization engine 550 applies one or more constraints supplied by the data acquisition and preparation module 520 to generate combined forecast results. The combined forecast results are provided to the presentation and reporting module 560, which is used to produce graphs and reports of the combined forecast results that can be displayed via the user interface 510.

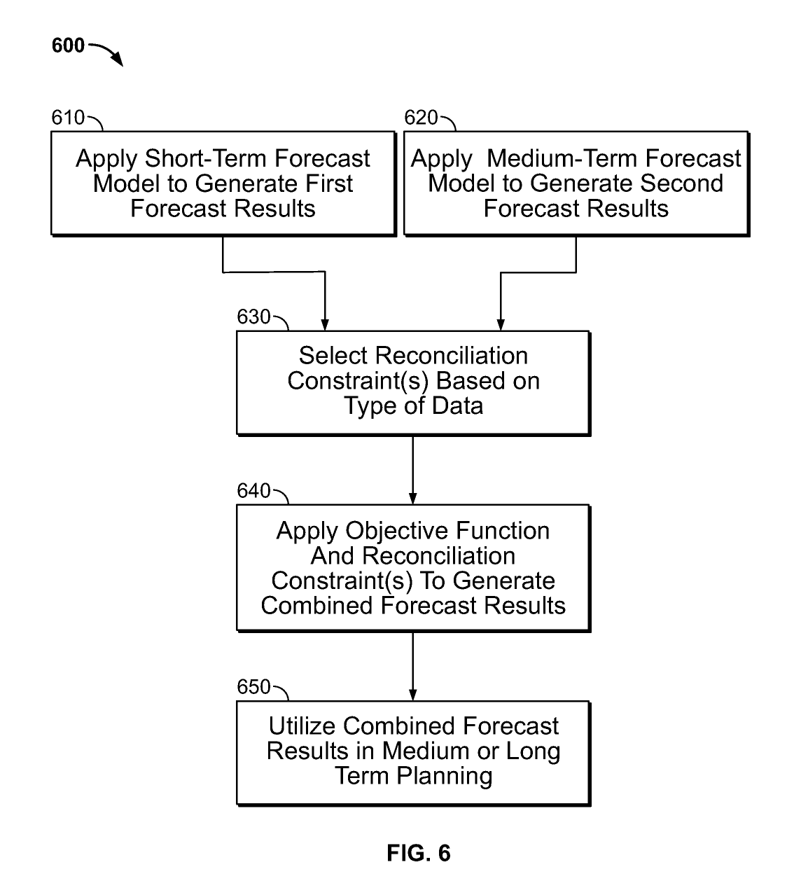

FIG. 6 is a flowchart 600 depicting operations of an example method for generating a forecast. At 610, a first forecast model is applied to generate first forecast results. The first forecast model may be a short-term forecast model (e.g., a time-series forecast model). At 620, a second forecast model is applied to generate second forecast results. The second forecast model may be a medium-term forecast model (e.g., an econometric forecast model). At 630, one or more reconciliation constraints are selected based on a type of data being forecast. In one example, the type of data may be indicative of a domain type (e.g., industry) to which the forecast applies, such that the one or more reconciliation constraints are set based on the indicated domain type. The first and second forecast results and the one or more reconciliation constraints are received by an optimization engine. At 640, the optimization engine applies an objective function and the one or more reconciliation constraints to combine the first and second forecast results to generate combined forecast results. The one or more reconciliation constraints are applied to preserve one or more attributes of the first or second forecast results in the combined forecast results. At 650, the combined forecast results are utilized in medium or long term planning.

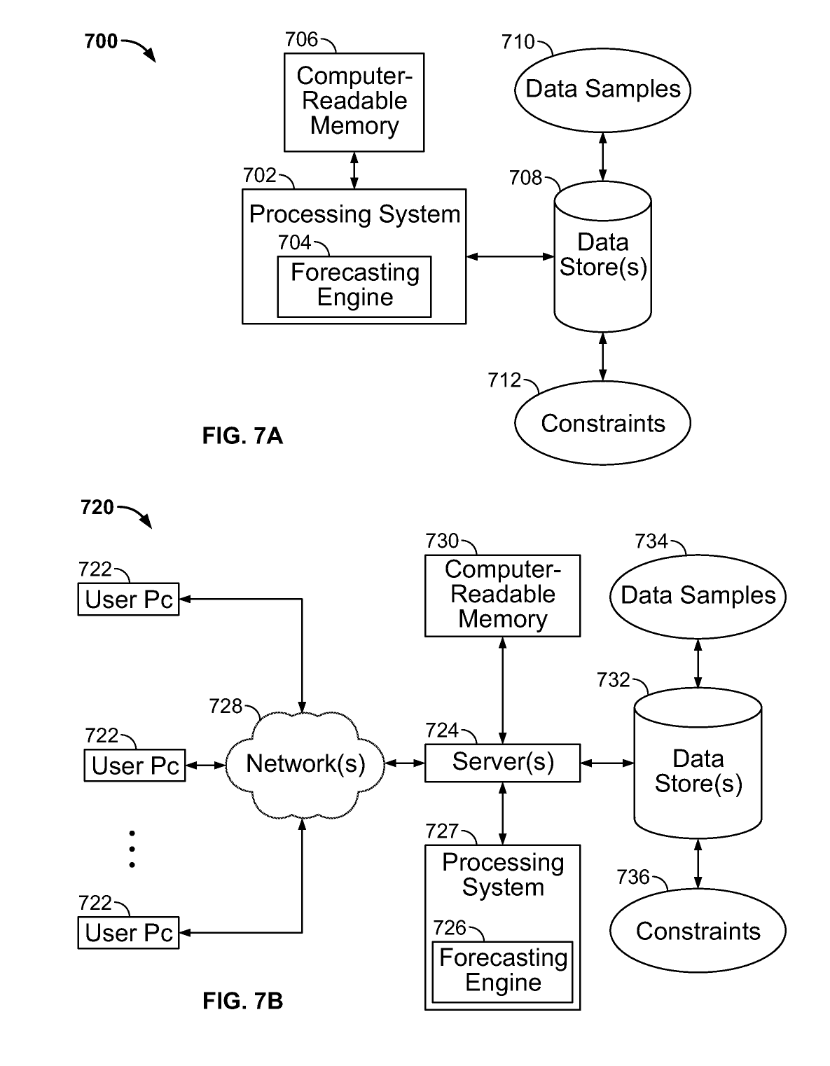

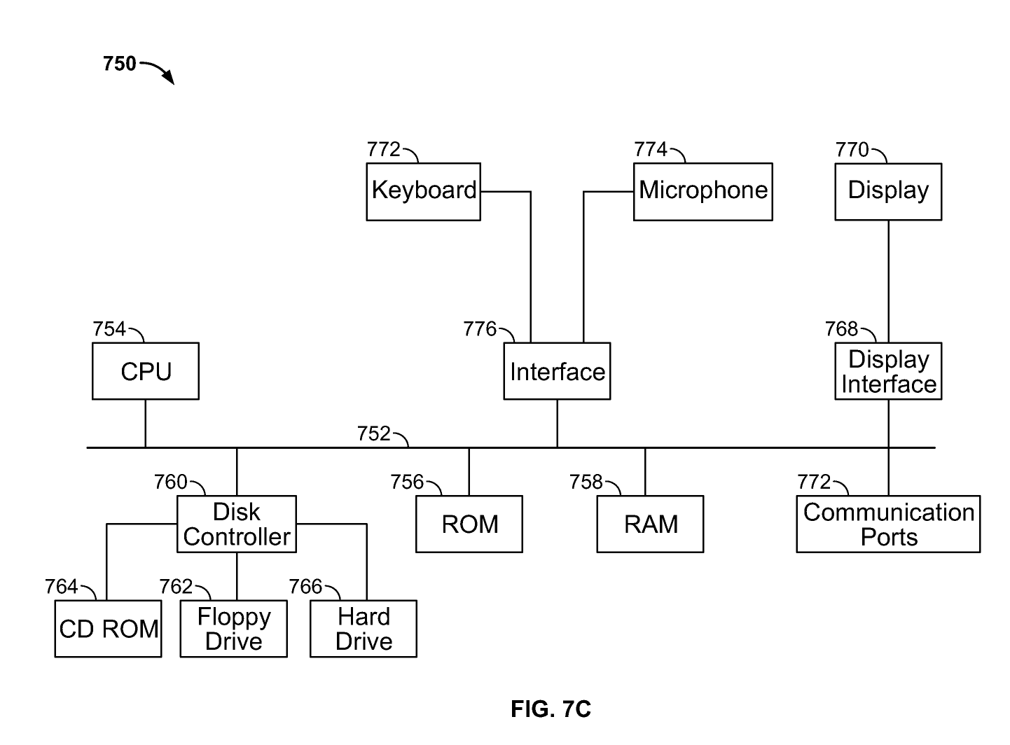

FIGS. 7A, 7B, and 7C depict example systems for use in generating a forecast. For example, FIG. 7A depicts an exemplary system 700 that includes a standalone computer architecture where a processing system 702 (e.g., one or more computer processors located in a given computer or in multiple computers that may be separate and distinct from one another) includes a forecasting engine 704 being executed on it. The processing system 702 has access to a computer-readable memory 706 in addition to one or more data stores 708. The one or more data stores 708 may include data samples 710 as well as constraints 712. The processing system 702 may be a distributed parallel computing environment, which may be used to handle very large-scale data sets.

FIG. 7B depicts a system 720 that includes a client-server architecture. One or more user PCs 722 access one or more servers 724 running a forecasting engine 726 on a processing system 727 via one or more networks 728. The one or more servers 724 may access a computer-readable memory 730 as well as one or more data stores 732. The one or more data stores 732 may contain data samples 734 as well as constraints 736.

FIG. 7C shows a block diagram of exemplary hardware for a standalone computer architecture 750, such as the architecture depicted in FIG. 7A that may be used to contain and/or implement the program instructions of system embodiments of the present disclosure. A bus 752 may serve as the information highway interconnecting the other illustrated components of the hardware. A processing system 754 labeled CPU (central processing unit) (e.g., one or more computer processors at a given computer or at multiple computers), may perform calculations and logic operations required to execute a program. A non-transitory processor-readable storage medium, such as read only memory (ROM) 756 and random access memory (RAM) 758, may be in communication with the processing system 754 and may contain one or more programming instructions for performing the method of generating a forecast. Optionally, program instructions may be stored on a non-transitory computer-readable storage medium such as a magnetic disk, optical disk, recordable memory device, flash memory, or other physical storage medium.

A disk controller 760 interfaces one or more optional disk drives to the system bus 752. These disk drives may be external or internal floppy disk drives such as 762, external or internal CD-ROM, CD-R, CD-RW or DVD drives such as 764, or external or internal hard drives 766. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 760, the ROM 756 and/or the RAM 758. The processor 754 may access one or more components as required.

A display interface 768 may permit information from the bus 752 to be displayed on a display 770 in audio, graphic, or alphanumeric format. Communication with external devices may optionally occur using various communication ports 772.

In addition to these computer-type components, the hardware may also include data input devices, such as a keyboard 773, or other input device 774, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

It is claimed:

1. A computer-implemented method for generating a forecast, comprising:
applying a first forecast model of a first type to generate first forecast results;
applying a second forecast model of a second type to generate second forecast results; and
combining the first and second forecast results using an optimization model to generate combined forecast results, the optimization model applying one or more constraints to preserve one or more attributes of the first or second forecast results in the combined forecast results.

2. The computer-implemented method of claim 1, further comprising:
setting the one or more constraints based on a type of data being forecast.

3. The computer-implemented method of claim 1, further comprising:
setting the one or more constraints based on a domain type to which the forecast applies.

4. The computer-implemented method of claim 3, further comprising:
setting the one or more constraints based on the domain type to which the forecast applies, wherein the domain type relates to a particular industry or a business type.

5. The computer-implemented method of claim 4, further comprising:
setting the one or more constraints based on the domain type to which the forecast applies, wherein the domain type relates to the particular industry or the business type, and wherein the particular industry or the business type relates to electrical power generation.

6. The computer-implemented method of claim 1, further comprising:
applying the first forecast model, wherein the first forecast model is a short-term forecast model; and
applying the second forecast model, wherein the second forecast model is a medium-term forecast model.

7. The computer-implemented method of claim 6, further comprising:
applying the first forecast model, wherein the first forecast model is the short-term forecast model, and wherein the short-term forecast model generates an hourly forecast; and
applying the second forecast model, wherein the second forecast model is the medium-term forecast model, and wherein the medium-term forecast model generates a monthly or yearly forecast.

8. The computer-implemented method of claim 1, further comprising:
applying the first forecast model, wherein the first forecast model is a time-series forecast model; and
applying the second forecast model, wherein the second forecast model is an econometric forecast model.

9. The computer-implemented method of claim 8, further comprising:
applying the one or more constraints to cause an aggregate demand forecasted by the econometric forecast to be preserved in the combined forecast results.

10. The computer-implemented method of claim 8, further comprising:
applying the one or more constraints to preserve magnitudes of peaks of the time-series forecast model in the combined forecast results.

11. The computer-implemented method of claim 8, further comprising:
applying the one or more constraints to require that no new peaks are created in the combined forecast results.

12. The computer-implemented method of claim 8, further comprising:
applying the one or more constraints to preserve temporal locations of peaks of time-series forecast results in the combined forecast results.

13. The computer-implemented method of claim 1, further comprising:
using the optimization model to associate an adjustment variable with time-series values from the first forecast results and to apply an objective function to minimize the adjustment variables.

14. The computer-implemented method of claim 13, further comprising:
applying the objective function to minimize the adjustment variables by minimizing a sum of the squared adjustment variables.

15. The computer-implemented method of claim 1, further comprising:
receiving the one or more constraints from a user via a user interface.

16. The computer-implemented method of claim 1, further comprising:
displaying a graphical representation of the combined forecast results.

17. The computer-implemented method of claim 1, further comprising:
using the optimization model to apply the one or more constraints to preserve attributes of both the first and the second forecast results in the combined forecast results.

18. The system for generating a forecast, comprising:
a first forecasting engine configured to apply a first forecast model of a first type to generate first forecast results;
a second forecasting engine configured to apply a second forecast model of a second type to generate second forecast results; and
an optimization engine configured to combine the first and second forecast results using an optimization model to generate combined forecast results, the optimization model applying one or more constraints to preserve one or more attributes of the first or second forecast results in the combined forecast results.

19. The system of claim 18, further comprising:
a data acquisition and preparation module configured to provide data or instructions to the first and the second forecasting engines.

20. The system of claim 19, wherein the data acquisition and preparation module is configured to provide second data or instructions to the optimization engine, and wherein the second data or instructions are used in combining the first and second forecast results.

21. The system of claim 20, wherein the second data or instructions include the one or more constraints, and wherein the data acquisition and preparation module is configured to analyze input data samples to determine the one or more constraints.

22. The system of claim 18, further comprising:
a presentation and reporting module configured to produce a graph or report of the combined forecast results.

23. The system of claim 18, further comprising:
a user interface configured to accept an input from a user or display an output of the system.

24. The system of claim 23, wherein the input includes the one or more constraints.

25. The system of claim 23, wherein the output includes a graphical representation of the first forecast results, the second forecast results, or the combined forecast results.

26. A computer program product for generating a forecast, tangibly embodied in a machine-readable non-transitory storage medium, including instructions configured to cause a data processing system to:
apply a first forecast model of a first type to generate first forecast results;
apply a second forecast model of a second type to generate second forecast results; and
combine the first and second forecast results using an optimization model to generate combined forecast results, the optimization model applying one or more constraints to preserve one or more attributes of the first or second forecast results in the combined forecast results.
